(19) United States
(12) Patent Application Publication
(10) Pub. No.: US 2026/0010324 A1
(43) Pub. Date: Jan. 8, 2026

(54) NON-TRANSITORY COMPUTER READABLE STORAGE MEDIUM, SERVER, AND LABEL DATA SHARING SYSTEM

(71) Applicant: BROTHER KOGYO KABUSHIKI KAISHA, Nagoya (JP)

(72) Inventor: Tetsuya Nose, Nagoya (JP)

(21) Appl. No.: 19/329,538

(22) Filed: Sep. 15, 2025

Related U.S. Application Data
(63) Continuation of application No. PCT/JP2024/010731, filed on Mar. 19, 2024.

(30) Foreign Application Priority Data
Mar. 31, 2023 (JP) 2023-058394

(51) Int. Cl. G06F 3/12; B41J 3/407

(52) U.S. Cl. CPC G06F 3/1273; B41J 3/4075; G06F 3/1203

(57) ABSTRACT

A non-transitory computer readable storage medium storing a program executable by a server, the server being capable of accessing a label database, the label database being capable of registering label data, a label ID for identifying the label data, and the number of printing times for each piece of medium information indicating a printing medium corresponding to the label data in association with each other, the label data being data printable by a label printer. The program causes a computer of the server to: a transmission process; an acquisition process; an addition process; and a return process.

### REFERENCE TO RELATED APPLICATIONS

This is a continuation application of International Application No. PCT/JP2024/010731 filed on March 19, 2024, which claims priority from Japanese Patent Application No. 2023-058394 filed on March 31, 2023. The entire contents of the aforementioned applications are incorporated herein by reference.

### BACKGROUND ART

In a related art, as a system for sharing content data, a system is known in which a server for storing content data is prepared on the Internet and the content data is downloaded to a device of a user.

In a point management system disclosed in the related art, photograph data is uploaded from a PC of a user A to a WWW server, and the photograph data is purchased by a PC of a user B and downloaded from the WWW server.

In recent years, a system for sharing label data used for printing a label in a label printer has been studied, and when the label data is shared, a mechanism for proposing a printing medium suitable for the label data to a user is desired. The related art discloses a system in which photograph data is shared via the WWW server, but does not disclose a mechanism for proposing a consumable item used for uploaded photograph data.

### SUMMARY

An object of the technique disclosed in the present specification is to realize a technique capable of proposing a printing medium suitable for label data in a system for sharing label data.

A non-transitory computer readable storage medium storing a program executable by a server, the server being capable of accessing a label database, the label database being capable of registering label data, a label ID for identifying the label data, and the number of printing times for each piece of medium information indicating a printing medium corresponding to the label data in association with each other, the label data being data printable by a label printer, wherein

the program causes a computer of the server to

execute, when a download request in which one piece of the label data registered in the label database is specified is received from a first information processing device, a transmission process of transmitting the specified label data to the first information processing device associated with the corresponding label ID,

the program further causes the computer of the server to

execute an acquisition process of acquiring a printing log, the printing log being output from the first information processing device when the first information processing device causes the label printer to perform printing based on the label data received from the server, and the printing log including the label ID corresponding to the printed label data, and medium information indicating a printing medium used for printing,

the program further causes the computer of the server to

execute an addition process of accessing the label database, and adding the number of printing times corresponding to the medium information included in the printing log acquired in the acquisition process among the number of printing times associated with the label ID included in the printing log acquired in the acquisition process, and

the program causes the computer of the server to

execute, when a proposal request in which one piece of the label data registered in the label database is specified is received from a second information processing device, a return process of accessing the label database, extracting a printing medium having a high use frequency based on the number of printing times for each piece of medium information corresponding to the label data specified in the proposal request, and returning proposal information including the extracted printing medium.

### BRIEF DESCRIPTION OF THE DRAWINGS

FIG. 1 is a diagram schematically illustrating a label data sharing system.

FIG. 2A is a schematic diagram illustrating an electrical configuration of a label management server. FIG. 2B is a schematic diagram illustrating an electrical configuration of a printing log server.

FIG. 3A is a diagram illustrating an example of user related information stored in a user database. FIG. 3B is a diagram illustrating an example of posting label related information stored in a posting label database. FIG. 3C is a diagram illustrating an example of the number of printing times per printing sheet in the posting label related information stored in the posting label database. FIG. 3D is a diagram illustrating an example of printing log related information stored in a printing log database.

FIG. 4 is a sequence diagram illustrating an example of a procedure of a posting process of a label provided to a user by a label management server program of a label management server, including an operation of a client application of a terminal.

FIG. 5 is a diagram schematically illustrating a terminal when a label is newly posted.

FIG. 6 is a sequence diagram illustrating an example of a procedure of a download process of a label provided to the user by the label management server program of the label management server, including operations of a printer application of a printer, a client application of a terminal, and the printing log server program of the printing log server.

FIG. 7A is a diagram schematically illustrating a terminal when a label is selected. FIG. 7B is a diagram schematically illustrating a terminal in a state where a preview screen of the selected label is displayed.

FIG. 8 is a sequence diagram illustrating an example of a procedure of a recommendation process provided to the user by the label management server program of the label management server, including operations of the printer application of the printer, the client application of the terminal, and the printing log server program of the printing log server. FIG. 9A is a diagram schematically illustrating a terminal in a state where a recommendation guide screen is displayed. FIG. 9B is a diagram schematically illustrating a terminal after the "execute" button is touched on the recommendation guide screen.

FIG. 9A is a diagram schematically illustrating a terminal in a state where a recommendation guide screen is displayed. FIG. 9B is a diagram schematically illustrating a terminal after the "execute" button is touched on the recommendation guide screen.

### DESCRIPTION

### First Embodiment

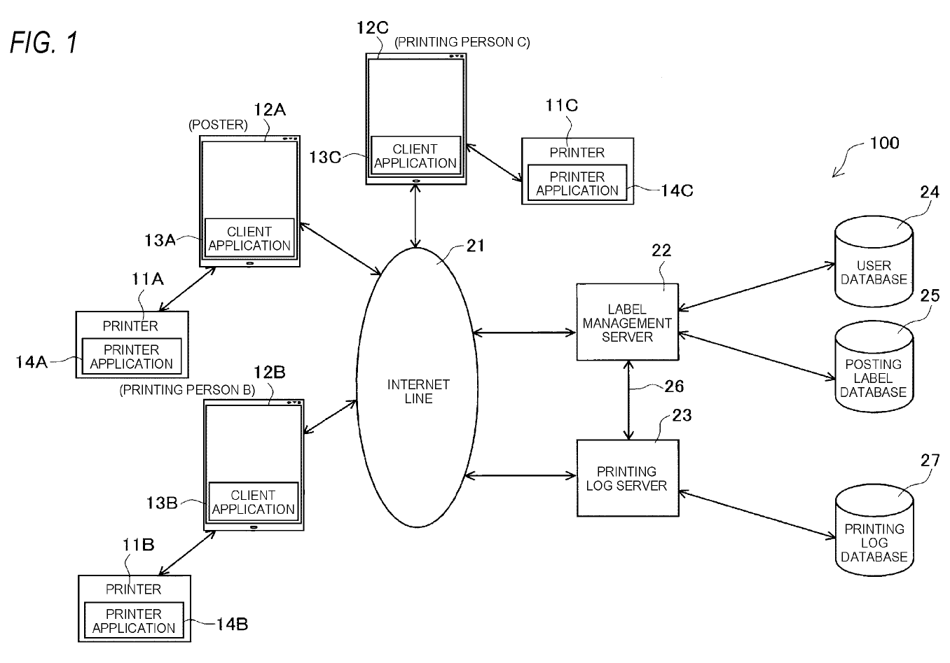

Hereinafter, an embodiment of a label data sharing system 100 according to the present embodiment will be described in detail with reference to the drawings. FIG. 1 is a diagram schematically illustrating the label data sharing system 100.

That is, as illustrated in FIG. 1, the label data sharing system 100 according to the present embodiment is a system provided to users by vendors (manufacturers) of a printer 11A, a printer 11B, and a printer 11C. In the label data sharing system 100 according to the present embodiment, an owner or a user (hereinafter, referred to as a user) of the printer 11A, the printer 11B, and the printer 11C can posting label data that can be printed by the printer 11A, the printer 11B, and the printer 11C from the owned terminal 12A, terminal 12B, and terminal 12C, that is, can upload the label data to the label management server 22.

Further, in the label data sharing system 100 according to the present embodiment, each of the printer 11A, the printer 11B, the printer 11C, the terminal 12A, the terminal 12B, and the terminal 12C may be implemented by one device or a plurality of devices. The printer 11A, the printer 11B, and the printer 11C are examples of a label printer. The terminal 12B is an example of a first information processing device. The terminal 12C is an example of a second information processing device. The terminal 12A is an example of a third information processing device.

Further, in the label data sharing system 100 according to the present embodiment, the user of the printer 11A, the printer 11B, and the printer 11C can create a label by downloading the label data from the label management server 22 to the terminal 12A, the terminal 12B, and the terminal 12C owned by the user, and then performing printing on a printing sheet based on the label data using the printer 11A, the printer 11B, and the printer 11C connected to the terminal 12A, the terminal 12B, and the terminal 12C. The printing sheet is an example of a printing medium. The printer 11A, the printer 11B, and the printer 11C may be capable of performing printing on a printing medium other than a sheet such as cloth, in addition to a printing sheet.

The terminal 12A, the terminal 12B, and the terminal 12C are implemented by smartphones owned by the user, and may be implemented by tablets or personal computers. Further, various application programs (hereinafter, referred to as apps) are stored in the terminal 12A, the terminal 12B, and the terminal 12C, and for example, a client application 13A, a client application 13B, and a client application 13C provided to users by vendors of the printer 11A, the printer 11B, and the printer 11C are stored. The client application 13A, the client application 13B, and the client application 13C have a function of creating and editing a label on the terminal 12A, the terminal 12B, and the terminal 12C, respectively.

The client application 13A, the client application 13B, and the client application 13C have a function of uploading the created label data to the label management server 22. The client application 13A, the client application 13B, and the client application 13C have a function of downloading label data from the label management server 22. The client application 13A, the client application 13B, and the client application 13C have a function of printing label data created or label data downloaded on the terminal 12A, the terminal 12B, and the terminal 12C on a printing sheet using the printer 11A, the printer 11B, and the printer 11C.

The printer 11A, the printer 11B, and the printer 11C may be collectively referred to as a "printer 11" when it is not necessary to distinguish the printer 11A, the printer 11B, and the printer 11C from each other. In addition, the terminal 12A, the terminal 12B, and the terminal 12C may be collectively referred to as a "terminal 12" when it is not necessary to distinguish the terminal 12A, the terminal 12B, and the terminal 12C from each other. In addition, the client application 13A, the client application 13B, and the client application 13C may be collectively referred to as a "client application 13" when it is not necessary to distinguish the client application 13A, the client application 13B, and the client application 13C from each other.

Further, a printer application 14A, a printer application 14B, and a printer application 14C for performing print control of the printer 11A, the printer 11B, and the printer 11C are stored in the printer 11A, the printer 11B, and the printer 11C, respectively. The printer 11 is a label printer capable of printing a label, and may be an inkjet printer or a laser printer. The printer 11 is connected to the terminal 12 by wireless LAN communication such as Wi-Fi (registered trademark) or short-range wireless communication such as Bluetooth (registered trademark). Further, the printer 11 and the terminal 12 may be connected by wire using a USB communication standard. The printer application 14A, the printer application 14B, and the printer application 14C may be collectively referred to as a "printer application 14" when it is not necessary to distinguish the printer application 14A, the printer application 14B, and the printer application 14C from each other.

Next, the label management server 22 and the printing log server 23 constituting the label data sharing system 100 according to the present embodiment will be described, the label management server 22 and the printing log server 23 are respectively connected to a large number of terminals 12 via an Internet line 21. The label management server 22 and the printing log server 23 may be connected via the Internet line 21 or may be connected via a wired LAN line 26. A user database 24 and a posting label database 25 are connected to the label management server 22 in an accessible manner. A printing log database 27 is connected to the printing log server 23 in an accessible manner. The label management server 22 is an example of a server.

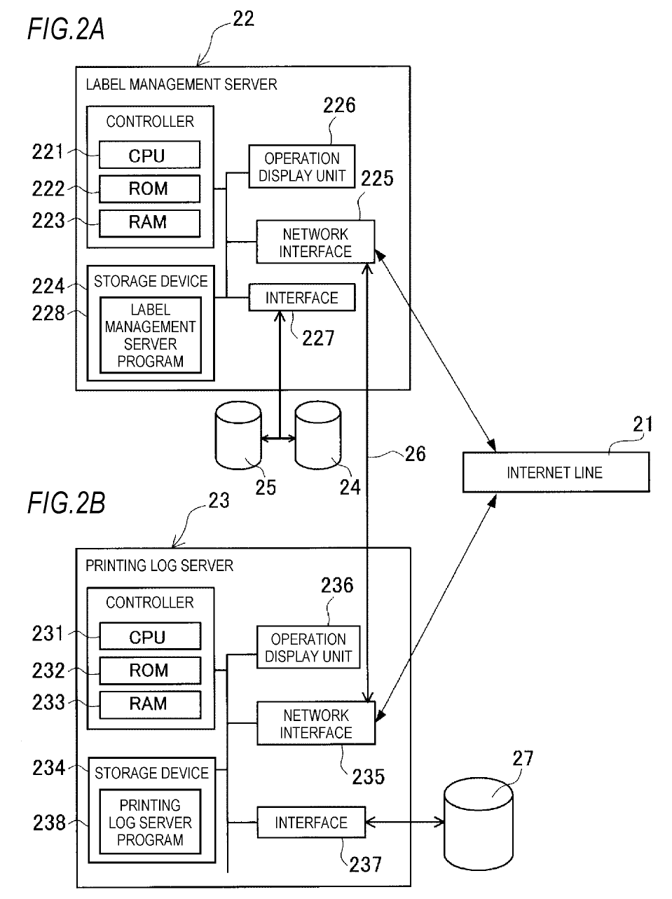

As illustrated in FIG. 2A, the label management server 22 includes a CPU 221, a ROM 222, a RAM 223, a storage device 224, a network interface 225, an operation display unit 226, and an interface 227. The ROM 222 stores an activation program for activating the label management server 22 and the like. The RAM 223 is used as a work area when various kinds of processes are executed, or as a storage area for temporarily storing data.

The storage device 224 includes an HDD, a flash memory, or the like, and stores a label management server program 228 and various kinds of processing programs.

The CPU 221 executes various kinds of processes in accordance with programs read from the ROM 222 and the storage device 224.

In the present embodiment, the network interface 225 is implemented by an interface of a wired LAN communication standard. In addition, the network interface 225 may be, for example, an interface of a wireless LAN communication standard such as Wi-Fi (registered trademark), an interface of a USB communication standard, or an interface of a short-range wireless communication standard such as Bluetooth (registered trademark). The network interface 225 is connected to the Internet line 21.

The operation display unit 226 includes, for example, a display device and a touch panel disposed on the display device. The display device displays necessary information, and the touch panel receives an input from a user.

In the present embodiment, the interface 227 is implemented by an interface of a wired LAN communication standard, and is connected to the user database 24 and the posting label database 25. The label management server 22 may include the user database 24 and the posting label database 25.

As illustrated in FIG. 2B, the printing log server 23 includes a CPU 231, a ROM 232, a RAM 233, a storage device 234, a network interface 235, an operation display unit 236, and an interface 237. The ROM 232 stores an activation program for activating the printing log server 23 and the like. The RAM 233 is used as a work area when various kinds of processes are executed, or as a storage area for temporarily storing data.

The storage device 234 includes, for example, an HDD, or a flash memory, and stores a printing log server program 238 and various kinds of processing programs.

The CPU 231 executes various kinds of processes in accordance with programs read from the ROM 232 and the storage device 234.

In the present embodiment, the network interface 235 is implemented by an interface of a wired LAN communication standard. In addition, the network interface 235 may be, for example, an interface of a wireless LAN communication standard such as Wi-Fi, an interface of a USB communication standard, or an interface of a short-range wireless communication standard such as Bluetooth. The network interface 235 is connected to the network interface 225 of the label management server 22 via the wired LAN line 26.

The operation display unit 236 includes, for example, a display device and a touch panel disposed on the display device. The display device displays necessary information, and the touch panel receives an input from a user.

In the present embodiment, the interface 237 is implemented by an interface of a wired LAN communication standard, and is connected to the printing log database 27. The printing log database 27 may be included in the printing log server 23.

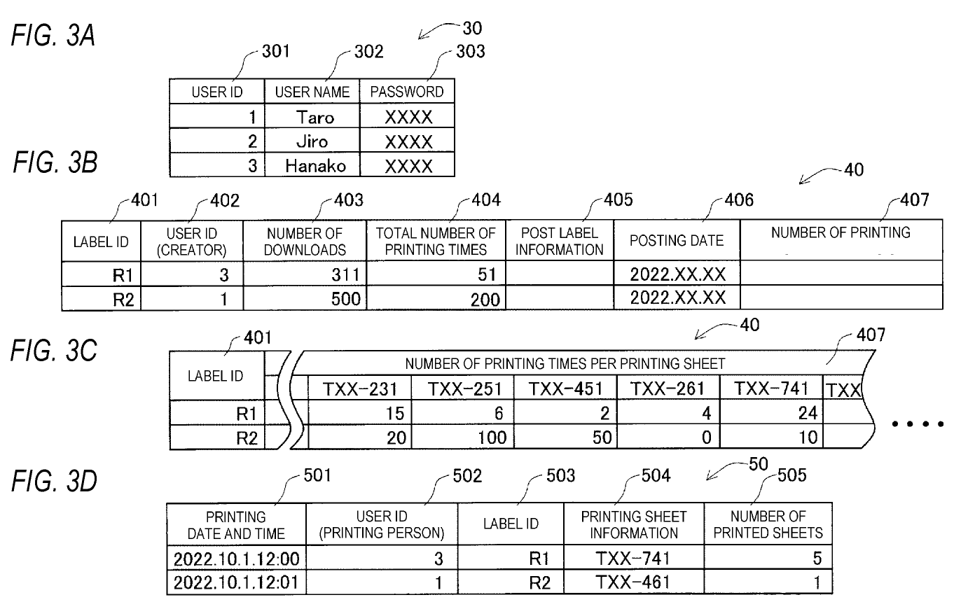

The user database 24 stores user related information 30 illustrated in FIG. 3A as a table. The user related information 30 includes a user ID 301, a user name 302, and a password 303 for each user.

The user ID 301 is identification information for identifying a user to whom the label data sharing system 100 according to the present embodiment is provided, and specifies a user who uses the terminal 12. The user name 302 is a name, a nickname, an address, a contact address, a mail address, or the like of an individual or an organization (corporation) of a user to whom a label sharing service according to the present embodiment is provided. When the user ID 301 posts a label for the first time using the label data sharing system 100 according to the present embodiment, a user ID for specifying a user who posts the label is newly set and additionally stored in the user ID 301. At the time of posting, the user name or the like input by the user on the terminal 12 is additionally stored in the user name 302 corresponding to the newly set user ID.

The password 303 is a password set by each user and stored in the user name 302.

The posting label database 25 stores posting label related information 40 illustrated in FIG. 3B as a table. The posting label related information 40 includes, for each label data posted in the label data sharing system 100 according to the present embodiment, a label ID 401, a user ID 402, the number of downloads 403, total number of printing times 404, posting label data 405, a posting date 406, and the number of printing times per printing sheet 407. The posting label database 25 is an example of a label database.

The label ID 401 is a serial number sequentially assigned to each label data registered in the posting label database 25 in the label data sharing system 100 according to the present embodiment. The user ID (creator) 402 is a user ID 301 of a user who posts label data using the label data sharing system 100 according to the present embodiment. The number of downloads 403 is the number of downloads of the posting label data. The total number of printing times 404 is the number of printing times of the posting label data, and is the same value as the total of the number of printing times for each sheet stored in the number of printing times per printing sheet 407.

The posting label data 405 is posting label data, and is data indicating a label configuration. The posting date 406 is a date when the label data is posted by a user. As illustrated in FIG. 3C, the number of printing times per printing sheet 407 stores a model number of a cassette that stores the printing sheet and the number of printing times using the cassette of the model number in association with each label ID 401. That is, as the number of printing times per printing sheet 407, for example, when the label ID 401 is R1, the model number of the cassette is "TXX- 231", the number of printing times "15" using the cassette are stored in association with each other, and the number of printing times is similarly stored for the model numbers of the other cassettes. Similarly, in another label ID 401, the model number of the cassette and the number of printing times using the cassette are stored in association with each other.

Further, when the printing sheet recommended by a vendor (manufacturer) of the printer 11 or the poster of the label data is set as the number of printing times per printing sheet 407, the model number of the cassette that stores the recommended printing sheet and the symbol or the number of times indicating the recommendation, for example, "99999" may be stored in association with each other.

In the present embodiment, the printing sheet is formed of an elongated sheet. Therefore, the model number of the cassette that stores the printing sheet is determined by a combination of a length in the width direction of the printing sheet stored in the cassette, a ground color of the printing sheet, a color of the ink used for printing, that is, a character color, and the like. That is, when the model number of the cassette is specifically described by taking an example, for example, the model number "TXX-231" of the cassette has a length of 12 mm in the width direction of the printing sheet, the ground color of the printing sheet is white, and the character color is black. In addition, the model number "TXX-241" of the cassette has a length of 18 mm in the width direction of the printing sheet, the ground color of the printing sheet is white, and the character color is black. The model number "TXX-741" of the cassette has a length of 18 mm in the width direction of the printing sheet, the ground color of the printing sheet is green, and the character color is black.

The printing log database 27 stores printing log related information 50 illustrated in FIG. 3D as a table. The printing log related information 50 includes a printing date and time 501, a user ID (printing person) 502, a label ID 503, printing sheet information 504, and number of printed sheets 505.

The printing date and time 501 is a date and time when the label is printed by the printer 11 in the label data sharing system 100 according to the present embodiment. The user ID (printing person) 502 is the user ID 301 of a user who has printed a label by the printer 11. The label ID 503 is the label ID 401 of the label printed by the printer 11. The printing sheet information 504 is printing sheet (label) information when the user performs printing using the printer 11 in the label data sharing system according to the present embodiment. The printing sheet (label) information is configured by the model number of the cassette that accommodates the printing sheet. The number of printed sheets 505 is the number of printed sheets of the label printed by the printer 11. The printing sheet (label) information is an example of the medium information.

In the present embodiment, the printing sheet (label) information is configured by the model number of the cassette that accommodates the printing sheet, and may be configured by a combination of, for example, a length of a width of the printing sheet, a ground color of the printing sheet, a color of the ink used for printing, that is, a character color.

### Posting Process of Label

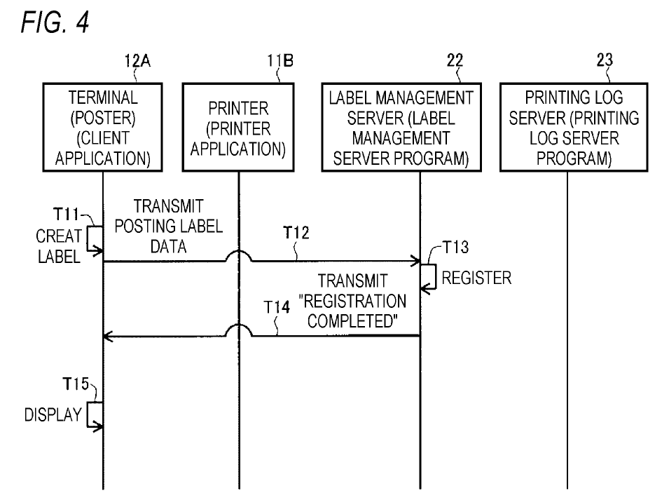

Next, an example of a procedure of a posting process of label data executed by the label management server program 228 of the label management server 22 including an operation of the client application 13 of the terminal 12 according to the present embodiment will be described with reference to a sequence diagram of FIG. 4.

Processing steps of the present embodiment basically indicate processes of the CPU of the device according to instructions described in programs stored in the device that executes the processes. The processes by the CPU also include hardware control using API of the OS. In the present specification, a detail description of the OS is omitted, and an operation of each program is described.

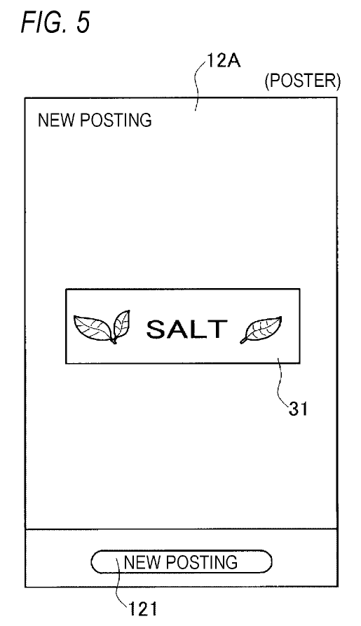

In the posting process of label according to the present embodiment, first, a user (hereinafter, referred to as a poster) who intends to posting label data activates the client application 13A of the terminal (poster) 12A, and then creates, for example, label data 31 as illustrated in FIG. 5 on the terminal (poster) 12A (procedure 11 (hereinafter, referred to as Ti1)). The label data 31 created in advance may be selected and read.

Thereafter, when the poster touches a "new posting" button 121 displayed on the terminal (poster) 12A, the client application 13A of the terminal (poster) 12A transmits, to the label management server 22, the user ID of the poster, posting label data which is label data created by the poster, sheet size information suitable for printing the posting label data, printing sheet (label) information recommended by the poster, and the like (T12). For example, the label management server program 228 provides a web page for posting, the web page is displayed by a browser function of the client application 13A, the user ID is input when logging in to the label management server 22 via the web page, and then an instruction to transmit the posting label data is input via the web page, so that the posting label data, the sheet size information, the printing sheet (label) information recommended by the poster, and the like are uploaded to the label management server 22.

Thus, the label management server 22 that has received the posting label data and the like transmitted from the terminal (poster) 12A stores the received posting label data and the like in the posting label database 25 (T13). The process of T13 is an example of a registration process. Specifically, the label management server 22 creates a new label ID and stores the new label ID in the posting label database 25 as a new label ID 401 of the posting label related information 40. Thereafter, in the table of the posting label related information 40 corresponding to the new label ID 401, the received user ID 301 of the poster is stored as the user ID (creator) 402, the received posting label data is stored as the posting label data 405, and the date of posting is stored as the posting date 406.

When the poster sets recommended printing sheet (label) information with respect to the posting label data, the label management server 22 stores, in the posting label database 25, the model number of the cassette that storing the printing sheet of the recommended printing sheet (label) information, the symbol or the number of times indicating the recommendation, for example, "99999" in association with each other.

Next, the label management server 22 transmits "registration completed" to the terminal (poster) 12A (T14). The terminal (poster) 12A that has received the "registration completed" displays, on the display unit, the fact that the registration of the posting label has been completed, and notifies the poster (T15). Accordingly, the poster can know that the posting label data has been registered in the label data sharing system 100.

### Download Process of Label Data

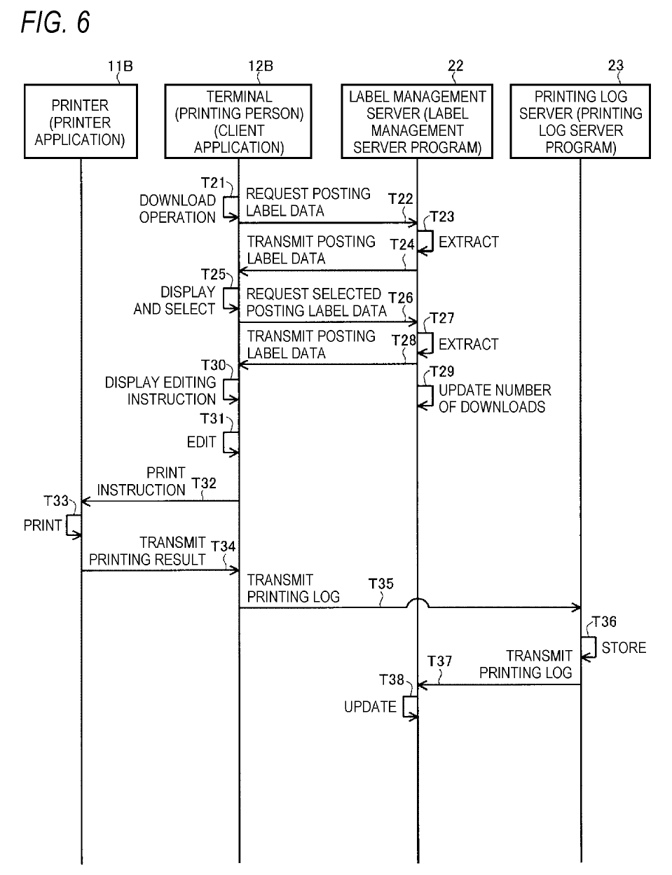

Next, an example of a procedure of a download process of the label data provided to the user by the label management server program 228 of the label management server 22 including operations of the printer application 14 of the printer 11, the client application 13 of the terminal 12, and the printing log server program 238 of the printing log server 23 according to the present embodiment will be described with reference to a sequence diagram of FIG. 6.

In the download process of the posting label data according to the present embodiment, first, when a user (hereinafter, referred to as a printing person B) who intends to download the posting label data activates the client application 13B of the terminal (printing person B) 12B and then touches a "label download" button (not illustrated) displayed on the terminal (printing person B) 12B (T21), the terminal (printing person B) 12B requests the posting label data from the label management server 22 (T22). For example, the label management server program 228 provides a web page for log in, displays the web page according to a browser function of the client application 13B, and inputs the user ID through the web page, thereby transmitting the user ID. When the login is approved, the label management server 22 receives a request for posting label data.

Next, the label management server 22 that has received the request for the posting label data extracts posting label data stored as the posting label data 405 from the posting label database 25 together with the label ID stored as the label ID 401 (T23). At this time, when a plurality of pieces of posting label data are stored as the posting label data 405, the label management server 22 extracts the plurality of pieces of posting label data and label IDs. The posting label data extracted at this time may be thumbnail image data of a label. Thereafter, the label management server 22 transmits the extracted posting label data to the terminal (printing person B) 12B together with the label ID or the like (T24).

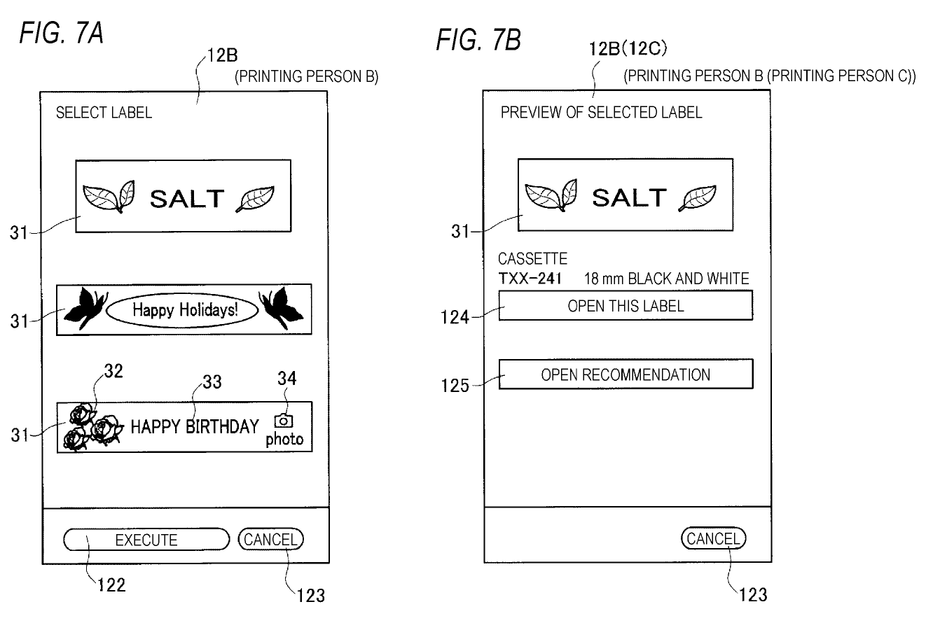

Next, the terminal (printing person B) 12B that has received the posting label data and the label ID displays the received posting label data on a display unit of the terminal (printing person B) 12B (T25). For example, the label management server program 228 provides a web page for selecting posting label data, displays a web page based on the browser function of the client application 13B, and displays a list of pieces of posting label data via the web page. Specifically, in the present embodiment, as illustrated in FIG. 7A, three pieces of label data 31 are displayed on the display unit of the terminal (printing person B) 12B. When there are a large number of pieces of label data 31, the label data 31 may be sequentially displayed by the printing person performing a scroll operation, or the label data 31 may be sequentially displayed by a display page switching operation.

Next, when the printing person touches the "execute" button 122 after selecting one of the plurality of pieces of posting label data displayed on the terminal (printing person B) 12B (T25), the user ID of a download executor and the label ID of the selected label data 31 are input from the terminal (printing person B) 12B to the label management server 22, and the download of the selected posting label data is requested (T26).

In the present embodiment, when the printing person touches the "execute" button 122 after selecting one of the plurality of pieces of posting label data displayed on the terminal (printing person B) 12B, the printing person may be charged according to the posting label data, and a part of the amount may be returned to the poster. With this configuration, it can be expected that the poster is motivated to post the next label data.

Then, the label management server 22 that has received a download request for the posting label data extracts the posting label data stored in the posting label data 405 from the posting label database 25 based on the label ID for the requested posting label data (T27). The label management server 22 transmits the extracted posting label data to the terminal (printing person B) 12B (T28). The label management server 22 counts up a value of the number of downloads 403 of the posting label related information 40 stored in the posting label database 25 by one based on the received label ID (T29). The process of T28 is an example of a transmission process.

On the other hand, the terminal (printing person B) 12B that has received the posting label data or the like displays the received label data 31 on the display unit of the terminal (printing person B) 12B (T30). Specifically, in the present embodiment, as illustrated in FIG. 7B, the label data 31 selected by one printing person is displayed in a portion above the vertical center on the display unit of the terminal (printing person B) 12B, and an "open this label" button 124 and an "open recommendation" button 125 are displayed at the center. In this state, when the printing person B touches the "open this label" button 124, the terminal (printing person B) 12B executes the editing mode of the label data 31 (T31), and when the printing person B touches a "print" button (not illustrated) in the editing mode, the terminal (printing person B) 12B transmits the posting label data and the like to the printer 11B to instruct printing (T32).

The printer 11B that has received the printing instruction prints the label based on the received posting label data or the like (T33). Next, the printer 11B that has finished printing the label transmits a printing result to the terminal (printing person B) 12B (T34). The printing result includes a printing date and time, a model number of the printing sheet cassette used when printing the label, and the number of printed sheets.

Next, the terminal (printing person B) 12B that has received the printing result transmits the printing log to the printing log server 23 (T35). The printing log includes the printing date and time, the user ID (printing person B), the label ID 401, the model number of the printing sheet cassette, the number of printed sheets, and the like. Next, the printing log server 23 that has received the printing log stores the received printing log as a new record (T36). Specifically, the printing date and time included in the printing log is stored as the printing date and time 501, the user ID of the printing person B who executes the printing included in the printing log is stored as the user ID (printing person) 502, the label ID 401 of the printed label included in the printing log is stored as the label ID 503, the model number of the printing sheet cassette included in the printing log is stored as the printing sheet information 504, and the number of printed sheets included in the printing log is stored as the number of printed sheets 505 (T36).

Next, since the printing log server 23 transmits the received printing log to the label management server 22, the label management server 22 receives the printing log (T37). Then, the label management server 22 that has received the printing log updates the total number of printing times and the number of printing times per printing sheet of the posting label related information 40 corresponding to the label ID 401 based on the received printing log (T38). Specifically, a value of the total number of printing times 404 corresponding to the label ID 401 is counted up based on the label ID 401 included in the received printing log and the number of printed sheets. In addition, based on the label ID 401 included in the received printing log, the model number of the printing sheet cassette, and the number of printed sheets, the value of the number of printing times per printing sheet 407 corresponding to the label ID 401 is counted up, that is, a value of the number of printing times corresponding to the model number of the printing sheet cassette is counted up. The process of T37 is an example of an acquisition process. The model number of the printing sheet cassette is an example of the medium information. The process of T38 is an example of an addition process.

In the present embodiment, the label management server 22 is configured to receive a printing log from the printing log server 23 and update the posting label related information 40, but is not limited thereto. For example, in T35, the terminal (printing person B) 12B may transmit the printing log to the label management server 22 when transmitting the printing log to the printing log server 23, and the label management server 22 may receive the printing log transmitted from the terminal (printing person B) 12B and update the posting label related information 40. The label management server 22 may request a printing log from the printing log server 23 periodically or at irregular intervals, for example, at the beginning or end of a month, the printing log server 23 that has received the request for a printing log may extract untransmitted printing log related information 50 from the printing log database 27 and transmit the untransmitted printing log related information 50 to the label management server 22, and the label management server 22 may update the posting label related information 40 based on the received printing log related information 50.

As described above, in the present embodiment, when many users download and then print the label data registered in the label data sharing system 100, the label management server 22 updates the number of printing times corresponding to the model number of the printing sheet cassette used for printing in the posting label database 25. As a result, in the model number of the printing sheet cassette used for printing by many users, the value of the number of printing times corresponding to the model number increases. Therefore, in the label data sharing system 100 according to the present embodiment, for each piece of label data registered in the label data sharing system 100, information on the number of printing times for each model number of the printing sheet cassette, that is, information on the use frequency for each model number of the printing sheet cassette can be accumulated.

### Recommendation Process

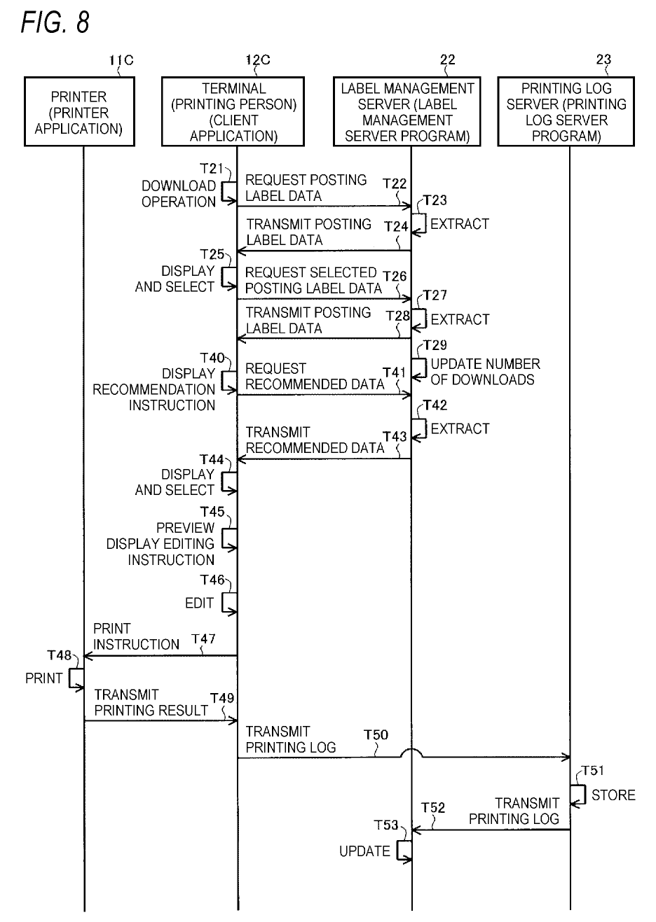

Next, an example of a procedure of a recommendation process provided to the user by the label management server program 228 of the label management server 22 including operations of the printer application 14 of the printer 11, the client application 13 of the terminal 12, and the printing log server program 238 of the printing log server 23 according to the present embodiment will be described with reference to a sequence diagram of FIG. 8. In the description, since the processes of T21 to T29 is the same as the processes of T21 to T29 in the download process of label data illustrated in FIG. 6 described above, the same reference numerals are given and description thereof will be omitted.

That is, in the recommendation process according to the present exemplary embodiment, first, the terminal (printing person C) 12C owned by the user (hereinafter, referred to as the printing person C) who intends to execute the recommendation process receives posting label data and the like from the label management server 22. Then, the terminal (printing person C) 12C that has received the posting label data or the like displays the received label data 31 in a portion above the vertical center on the display unit of the terminal (printing person C) 12C (T40). Specifically, in the present embodiment, on the display unit of the terminal (printing person C) 12C, one piece of label data 31 selected by the printing person C is displayed on an upper side, and the "open this label" button 124 and the "open recommendation" button 125 are displayed at the center (see FIG. 7B).

In this state, when the printing person C touches the "open recommendation" button 125, the terminal (printing person C) 12C requests recommended data from the label management server 22 (T41). The recommended data request command includes the label ID of the label data 31 selected in the process of T25, the user ID of the printing person, and the like.

Next, the label management server 22 that has received the request for recommended data searches the posting label related information 40 based on the label ID, and extracts the model number of the printing sheet cassette corresponding to the label ID and the value of the number of printing times corresponding to the model number. Thereafter, the model numbers of the printing sheet cassettes are sorted in descending order of the number of printing times, that is, in descending order of the use frequency, and codes indicating the order of the use frequency and the model numbers of the printing sheet cassettes are stored in association with each other (T42).

As described above, in the present embodiment, there is a high possibility that the number of printing times, that is, the printing sheet having a high use frequency is the printing sheet suitable for the label data as compared with the printing sheet having a low use frequency, and it is possible to improve convenience for the printing person by providing such information to the printing person.

In the present embodiment, when a recommended printing sheet is set for the label data corresponding to the label ID, the label management server 22 is configured to store the model number of the cassette that stores the recommended printing sheet and the symbol or the number of times indicating the recommendation in association with each other. Therefore, the label management server 22 can provide, to a printing person, information including the recommended printing sheet in addition to the printing sheet having a high use frequency. As a result, the printing medium recommended by a creator who creates the label data can also be proposed, so that the convenience for the printing person can be further improved. The recommendation may be that the vendor (manufacturer) of the printer 11 recommends a printing medium.

In the present embodiment, in the process of T42, when the posting label related information 40 is searched based on the label ID and the model number of the printing sheet cassette corresponding to the label ID and the value of the number of printing times corresponding to the model number are extracted, if the total number of printing times stored in the total number of printing times 404 is less than a threshold value, for example, 100 times, the model number of the printing sheet cassette corresponding to the label ID and the value of the number of printing times corresponding to the model number may not be extracted. In this case, when a recommended printing sheet is set for the label data corresponding to the label ID, only the model number of the cassette that stores the recommended printing sheet is stored.

Accordingly, when the total number of times of use is small, the recommended printing sheet is returned as the alternative information, and thus it is possible to recommend a suitable printing sheet even in an initial stage of using the label data, and to further improve convenience for the printing person.

The threshold value may be a fixed value or a variable value. The threshold value may be set by an administrator of the label data sharing system 100. The threshold value may be configured to vary depending on the value of the total number of printing times 404. That is, the threshold value may be configured to increase as the value of the total number of printing times 404 increases.

Next, the label management server 22 transmits, to the terminal (the printing person C) 12C, the model number of the cassette in which the code indicating the use frequency is paired, the model number of the cassette that stores the recommended printing sheet, and the like (T43). The process of T43 is an example of a return process. In addition, the model number of the cassette in which the code indicating the use frequency is paired and the model number of the cassette that stores the recommended printing sheet are examples of the proposal information.

In the present embodiment, at this time, when the total number of printing times stored in the total number of printing times 404 is smaller than the threshold value, the label management server 22 does not transmit the model number of the printing sheet cassette to the terminal (printing person C) 12C, and only the model number of the cassette that stores the recommended printing sheet is transmitted.

Next, the terminal (printing person C) 12C that has received the model number of the cassette in which the code indicating the use frequency is paired, the model number of the cassette that stores the recommended printing sheet, and the like converts the received model number of the cassette into the width of the corresponding printing sheet, the ground color of the sheet, and the character color for printing in descending order of the use frequency. The model number of the cassette may be converted into the width of the printing sheet, the ground color of the sheet, and the character color of the printing by using a conversion table or by executing a conversion program.

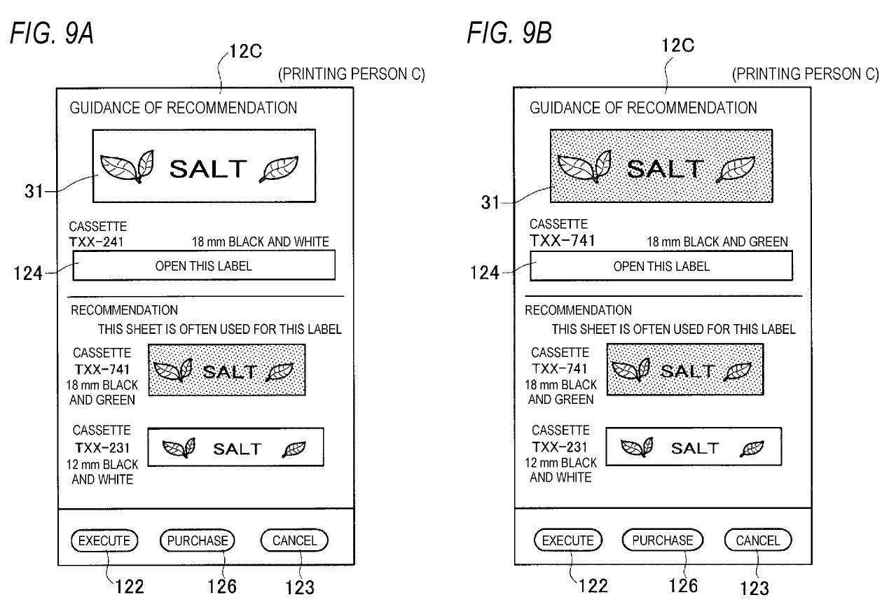

Next, as illustrated in FIG. 9A, the terminal (printing person C) 12C displays the label data 31 selected by the printing person on a lower side of the vertical center on the display unit of the terminal (printing person C) 12C in descending order of use frequency based on the converted width, ground color of the sheet, and the character color of printing (T44). At this time, when the model number of the cassette that stores the recommended printing sheet is received, the label data of the recommended printing sheet may be displayed at the top. When there are a large number of model numbers of the received cassettes and there are a large number of pieces of label data 31, the label data 31 may be sequentially displayed by the printing person C performing a scroll operation, or the label data 31 may be sequentially displayed by a display page switching operation.

Next, when the printing person C touches the "execute" button 122 (T44) after selecting one piece of the label data 31 displayed in a portion below a vertical center on the display unit of the terminal (printing person C) 12C, as illustrated in FIG. 9B, the terminal (printing person C) 12C previews the label data 31 selected by the printing person in a portion above the vertical center on the display unit of the terminal (printing person C) 12C based on a width of the selected sheet, a ground color of the sheet, and a character color of printing (T45).

In this state, when the printing person C touches the "open this label" button 124 (T45), the terminal (printing person C) 12C executes an editing mode of the label data 31 (T46). Since the subsequent processes of T47 to T53 are the same as the processes of T32 to T38 of the download process of label data illustrated in FIG. 6 described above, the description thereof will be omitted.

In this state, when the printing person C touches the "cancel" button 123, the terminal (printing person C) 12C ends the recommendation process.

Further, in this state, when the printing person C touches a "purchase" button 126, the printing person C can arrange to purchase the printing sheet (printing cassette) necessary for printing the label data 31 selected in the process of T44.

As described above in detail, the number of printing times for each piece of printing sheet that can be handled by the label data is stored in association with the label data, and when there is a request for recommended data for the label data, a printing sheet having a high use frequency is extracted and returned based on the number of printing times for each printing sheet that is associated with the label data, so that it is possible to propose a printing sheet suitable for the label data by the terminal (printing person C) 12C of the request source. Therefore, convenience for the user of the terminal is improved.

The embodiment disclosed in the present specification is merely an example, and does not limit the present invention. Therefore, various improvements and modifications can be naturally made to the technique disclosed in the present specification without departing from the gist of the present invention. The number of printers connected to the terminal is not limited to the illustrated example, and may be two or more.

In the present embodiment, a type of printing sheet is specified by the model number of the cassette, and the type of printing sheet may be specified by the width of the printing sheet, the ground color of the printing sheet, the character color of printing, or the like. For example, in the present embodiment, since the model number of the cassette can be acquired from the printer, the number of printing times is stored for each model number of the cassette as the number of printing times per printing sheet 407 (see FIG. 3C). In a case where the model number of the cassette cannot be acquired from the printer and some features of the sheet (the size of the sheet, the ground color of the sheet, the character color, and the like) can be acquired, the number of printing times may be stored for each combination of these features. For example, a combination of the width of the sheet, the ground color of the sheet, and the character color includes a combination of 24 mm in width/ground color black/character color white, a combination of 24 mm in width/ground color red/character color white, and a combination of 36 mm in width/ground color black/character color white. These combinations are also examples of the medium information. A combination having a high use frequency may be extracted from the number of printing times for each combination, and a sheet suitable for the extracted combination may be proposed.

In the present embodiment, the user database 24 and the posting label database 25 are connected to the label management server 22 in an accessible manner, and the printing log database 27 is connected to the printing log server 23 in an accessible manner. The label management server 22 and the printing log server 23 may be integrated into one server, and the user database 24, the posting label database 25, and the printing log database 27 may be connected to the integrated server in an accessible manner.

Further, in the present embodiment, the recommendation process is executed using the terminal 12C owned by the printing person C, and may be executed using the terminal 12A owned by the poster or the terminal 12B owned by the printing person B.

In any sequence diagram disclosed in the embodiment, an execution order of a plurality of processes can be freely changed or can be executed in parallel within a range in which no contradiction occurs in a processing content.

The processes disclosed in the embodiment may be executed by hardware such as a single CPU, a plurality of CPUs, and an ASIC, or a combination thereof. In addition, the processes disclosed in the embodiment can be implemented in various modes such as a recording medium in which a program for executing the processes is recorded, or a method.

According to the technique disclosed in the present specification, the number of printing times for each medium information indicating a printing medium corresponding to the label data is stored in association with the label data, and when there is a proposal request for the label data, a printing medium having a high use frequency is extracted and returned based on the number of printing times associated with the label data, so that it is possible to propose a printing medium suitable for the label data by the second information processing device of a proposal request source.

A server and a label data sharing system for realizing the functions of the above devices are also novel and useful.

An object of the technique disclosed in the present specification is to realize a technique capable of proposing a printing medium suitable for label data in a system for sharing label data.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A non-transitory computer readable storage medium storing a program executable by a server, the server being capable of accessing a label database, the label database being capable of registering label data, a label ID for identifying the label data, and the number of printing times for each piece of medium information indicating a printing medium corresponding to the label data in association with each other, the label data being data printable by a label printer, wherein the program causes a computer of the server to execute, when a download request in which one piece of the label data registered in the label database is specified is received from a first information processing device, a transmission process of transmitting the specified label data to the first information processing device associated with the corresponding label ID,the program further causes the computer of the server to execute an acquisition process of acquiring a printing log, the printing log being output from the first information processing device when the first information processing device causes the label printer to perform printing based on the label data received from the server, and the printing log including the label ID corresponding to the printed label data, and medium information indicating a printing medium used for printing,the program further causes the computer of the server to execute an addition process of accessing the label database, and adding the number of printing times corresponding to the medium information included in the printing log acquired in the acquisition process among the number of printing times associated with the label ID included in the printing log acquired in the acquisition process, andthe program further causes the computer of the server to execute, when a proposal request in which one piece of the label data registered in the label database is specified is received from a second information processing device, a return process of accessing the label database, extracting a printing medium having a high use frequency based on the number of printing times for each piece of medium information corresponding to the label data specified in the proposal request, and returning proposal information including the extracted printing medium.

2. The storage medium according to claim 1, wherein the label database is capable of storing the label data, the label ID, the number of printing times for each piece of medium information, and a recommended printing medium in association with each other, andthe proposal information returned by the return process includes the extracted printing
medium and the recommended printing medium corresponding to the label data specified in the proposal request.

3. The storage medium according to claim 1, wherein in the return process,when a total number of printing times for each piece of the medium information corresponding to the label data specified in the proposal request is less than a threshold value, the proposal information based on the number of printing times is not returned.

4. The storage medium according to claim 3, wherein the label database is capable of storing the label data, the label ID, the number of printing times for each piece of the medium information, and a recommended printing medium in association with each other,in the return process,if the total number of printing times for each piece of the medium information corresponding to the label data specified in the proposal request is not less than the threshold value, the proposal information based on the number of printing times is returned, andif the total number of printing times for each medium information corresponding to the label data specified in the proposal request is less than the threshold value, the proposal information based on the number of printing times is not returned, and alternative information indicating the recommended printing medium corresponding to the label data specified in the proposal request is returned.

5. The storage medium according to claim 1, wherein in the return process,the label database is accessed, a predetermined number of pieces of medium information in descending order of the number of printing times is extracted among the number of printing times for each piece of medium information corresponding to the label data specified in the proposal request, and proposal information including a printing medium indicated by the extracted medium information is returned.

6. The storage medium according to claim 1, wherein in the return process,the label database is accessed, the medium information having the number of printing times larger than a predetermined number of times is extracted among the medium information corresponding to the label data specified in the proposal request, and proposal information including a printing medium indicated by the extracted medium information is
returned.

7. The storage medium according to claim 1, wherein the server is capable of accessing a printing log database, the printing log database is capable of registering the printing log output from the first information processing device,the program causes the computer of the server to execute, when a predetermined acquisition condition is satisfied, the acquisition process, andin the acquisition process,the printing log database is accessed and the printing log registered within a predetermined period is acquired.

8. The storage medium according to claim 1, wherein the program causes the computer of the server to execute an upload reception process of receiving an upload instruction for label data from a third information processing device,the program further causes the computer of the server to execute, when the upload instruction for the label data is received in the upload reception process, a registration process of receiving posting label data which is the label data uploaded from the third information processing device, associating the received posting label data with the label ID assigned to the posting label data and the number of printing times for each piece of medium information indicating a printing medium corresponding to the posting label data, and registering the posting label data in the label database,the program further causes the computer of the server to execute, when the download request in which the posting label data is specified is received from the first information processing device, a transmission process of transmitting the posting label data to the first information processing device, andthe program further causes the computer of the server to execute, when the proposal request in which the posting label data is specified is received from the second information processing device, the return process of accessing the label database, extracting a printing medium having a high use frequency based on the number of printing times for each medium information corresponding to the posting label data, and returning the proposal information including the extracted printing medium.

9. A server connectable to a first information processing device and a second information processing device via a network,
the server being capable of accessing a label database, the label database being capable of registering label data, a label ID for identifying the label data, and the number of printing times for each piece of medium information indicating a printing medium corresponding to the label data in association with each other, the label data being data printable by a label printer, wherein the server is configured to execute, when a download request in which one piece of the label data registered in the label database is specified is received from the first information processing device, a transmission process of transmitting the specified label data to the first information processing device associated with the corresponding label ID,
the server is further configured to execute an acquisition process of acquiring a printing log, the printing log being output from the first information processing device when the first information processing device causes the label printer to perform printing based on the label data received from the server, and the printing log including the label ID corresponding to the printed label data, and medium information indicating a printing medium used for printing,
the server is further configured to execute an addition process of accessing the label database, and adding the number of printing times corresponding to the medium information included in the printing log acquired in the acquisition process among the number of printing times associated with the label ID included in the printing log acquired in the acquisition process, and
the server is further configured to execute, when a proposal request in which one piece of the label data registered in the label database is specified is received from the second information processing device, a return process of accessing the label database, extracting a printing medium with a high use frequency based on the number of printing times for each piece of medium information corresponding to the label data specified in the proposal request, and returning proposal information including the extracted printing medium.

10. A label data sharing system comprising a first information processing device, a second information processing device, and a server, the first information processing device and the second information processing device being connectable to the server via a network, wherein the server is capable of accessing a label database, the label database being capable of registering label data, a label ID for identifying the label data, and the number of printing times for each piece of medium information indicating a printing medium corresponding to the label data in association
with each other, the label data being data printable by a label printer,the first information processing device is capable of transmitting, to the server, a download request in which one piece of the label data registered in the label database is specified,the server is configured to when the download request is received from the first information processing device, transmit the specified label data to the first information processing device associated with the corresponding label ID,the server is further capable of acquiring a printing log, the printing log being output from the first information processing device when the first information processing device causes the label printer to perform printing based on the label data received from the server, and the printing log including the label ID corresponding to the printed label data, and medium information indicating a printing medium used for printing,the server is further capable of accessing the label database, and adding the number of printing times corresponding to the medium information included in the printing log among the number of printing times associated with the label ID included in the printing log acquired in the acquisition process,the second information processing device is capable of when one piece of the label data registered in the label database is selected, transmitting, to the server, a proposal request in which the selected label data is specified,the server is configured to when the proposal request is received from the second information processing device, access the label database, extract a printing medium having a high use frequency based on the number of printing times for each piece of medium information corresponding to the label data specified in the proposal request, and return proposal information including the extracted printing medium, andthe second information processing device is configured to execute, when the proposal information is received from the server, a process of proposing the printing medium included in the proposal information.
